(19) United States
(12) Patent Application Publication
(10) Pub. No.: US 2025/0113169 A1
(43) Pub. Date: Apr. 3, 2025

(54) SYSTEMS AND METHODS FOR COMMUNICATIONS AMONG NETWORK FUNCTIONS

(71) Applicant: ZTE CORPORATION, Shenzhen (CN)

(72) Inventors: Shuang LIANG, Shenzhen (CN); Jinguo ZHU, Shenzhen (CN); Menghan WANG, Shenzhen (CN); Xingyue ZHOU, Shenzhen (CN)

(73) Assignee: ZTE CORPORATION, Shenzhen (CN)

(21) Appl. No.: 18/979,001

(22) Filed: Dec. 12, 2024

Related U.S. Application Data
(63) Continuation of application No. PCT/CN2022/125862, filed on Oct. 18, 2022.

(51) Int. Cl. H04W 4/16; H04W 48/18; H04W 60/04

(52) U.S. Cl. CPC H04W 4/16; H04W 48/18; H04W 60/04

(57) ABSTRACT

The present arrangement relate to systems, methods, and non-transitory computer-readable media for storing a Network Function (NF) profile of Radio Access Network (RAN), the NF profile including a callback link, wherein the callback link corresponds to at least one service provided by the RAN; and communicating, by the RAN with an NF, information for the at least one service of the RAN using the callback link.

### CROSS-REFERENCE TO RELATED APPLICATION

This application claims the benefit of priority under 35 U.S.C. § 120 as a continuation of PCT Patent Application No. PCT/CN2022/125862, filed on Oct. 18, 2022, the disclosure of which is incorporated herein by reference in its entirety.

### TECHNICAL FIELD

The disclosure relates generally to wireless communications and, more particularly, to a Network Framework (NF).

### BACKGROUND

In 5th Generation Mobile Network System (5GC), an NF improves the flexibility and the scalability of the operator mobility network. The NF can provide more than one services such as registration, communication, and so on.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

In some arrangements, a Network Function (NF) profile of Radio Access Network (RAN) is stored, the NF profile including a callback link, wherein the callback link corresponds to at least one service provided by the RAN. The RAN can communicate with an NF information for the at least one service of the RAN using the callback link.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication system, according to some arrangements.

FIG. 2 illustrates block diagrams of an example base station and an example user equipment device, according to some arrangements.

FIG. 3 shows a 5GS architecture, according to some arrangements.

FIG. 4 is a diagram illustrating an example communication method between two NFs, according to various arrangements.

FIG. 5 is an example registration method for registering RAN services, according to various arrangements.

FIG. 6 is a diagram illustrating an example method of an access procedure, according to various arrangements.

FIG. 7 is a diagram illustrating an example method of a PDU session establishment procedure, according to various arrangements.

FIG. 8 is a diagram illustrating an example method for releasing the callback URI, according to various arrangements.

FIG. 9 is a diagram illustrating an example method for deactivating UP connection, according to various arrangements.

FIG. 10 is a diagram illustrating an example method for a paging procedure, according to various arrangements.

FIG. 11 is an example method for a notification procedure, according to some arrangements.

FIG. 12 is a flowchart diagram illustrating an example method for using an NF profile of a RAN, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

An NF service is one type of capability exposed by an NF (e.g., NF Service Producer) to authorized NF Service Consumers through a service-based interface. NFs can offer different capabilities and different NF services to different consumers. Thus, NF communications based on service interface is more flexible and scalable. The interface N2 between Next Generation Radio Access Network (NG-RAN) and Mobility Management Function (AMF) is not a service-based interface. The arrangements disclosed herein provides service-based interface for the interface N2 between the AMF and the NG-RAN.

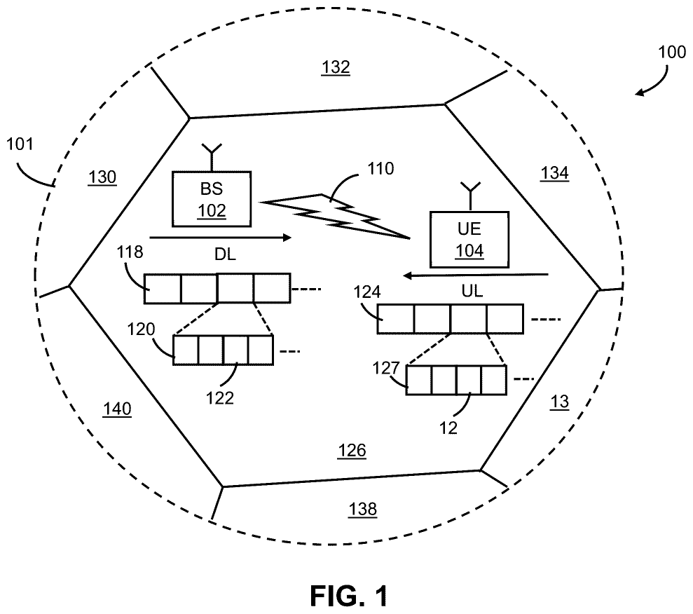

FIG. 1 illustrates an example wireless communication system 100 in which techniques disclosed herein may be implemented, in accordance with an implementation of the present disclosure. In the following discussion, the wireless communication system 100 can implement any wireless network, such as a cellular network or a narrowband Internet of things (NB-IoT) network, and is herein referred to as system 100. Such an example system 100 includes a BS 102 and a UE 104 that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one BS operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various implementations of the present solution.

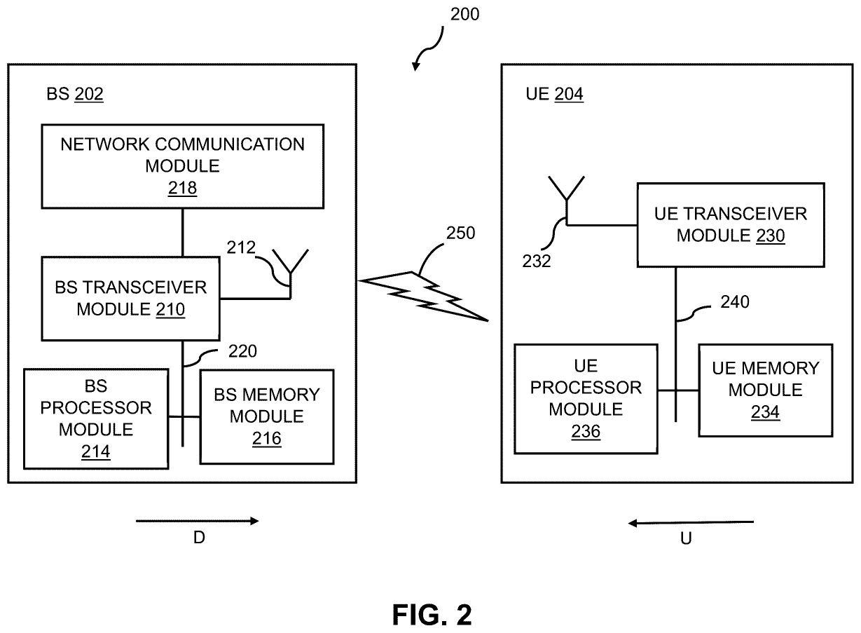

FIG. 2 illustrates a block diagram of an example wireless communication system 200 for transmitting and receiving wireless communication signals, e.g., OFDM/OFDMA signals, in accordance with some implementations of the present solution. The system 200 may include components and elements configured to support known or conventional operating features that need not be described in detail herein. In one illustrative implementation, system 200 can be used to communicate (e.g., transmit and receive) data symbols in a wireless communication environment such as the wireless communication environment 100 of FIG. 1, as described above.

System 200 generally includes a BS 202 and a UE 204. The BS 202 includes a Base Station (BS) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

The system 200 may further include any number of modules other than the modules shown in FIG. 2. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the UE transceiver 230 may be referred to herein as an uplink transceiver 230 that includes a Radio Frequency (RF) transmitter and a RF receiver each including circuitry that is coupled to the antenna 232. A duplex switch (not shown) may alternatively couple the uplink transmitter or receiver to the uplink antenna in time duplex fashion. Similarly, in accordance with some implementations, the BS transceiver 210 may be referred to herein as a “downlink” transceiver 210 that includes a RF transmitter and a RF receiver each including circuitry that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some implementations, there is close time synchronization with a minimal guard time between changes in duplex direction.

The UE transceiver 230 and the BS transceiver 210 are configured to communicate via the wireless data communication link 250, and cooperate with a suitably configured RF antenna arrangement 212/232 that can support a particular wireless communication protocol and modulation scheme. In some illustrative implementations, the UE transceiver 210 and the BS transceiver 210 are configured to support industry standards such as the Long Term Evolution (LTE) and emerging 5G and 6G standards, and the like. It is understood, however, that the present disclosure is not necessarily limited in application to a particular standard and associated protocols. Rather, the UE transceiver 230 and the BS transceiver 210 may be configured to support alternate, or additional, wireless data communication protocols, including future standards or variations thereof.

In accordance with various implementations, the BS 202 may be an evolved node B (eNB), a serving eNB, a target eNB, a femto station, or a pico station, for example. In some implementations, the UE 204 can be various types of user devices such as a mobile phone, a smart phone, a Personal Digital Assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the methods described in connection with the implementations disclosed herein may be implemented directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some implementations, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the BS 202 that enable bi-directional communication between BS transceiver 210 and other network components and communication nodes configured to communication with the BS 202. For example, network communication module 218 may be configured to support internet or WiMAX traffic. In a typical deployment, without limitation, network communication module 218 provides an 802.3 Ethernet interface such that BS transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

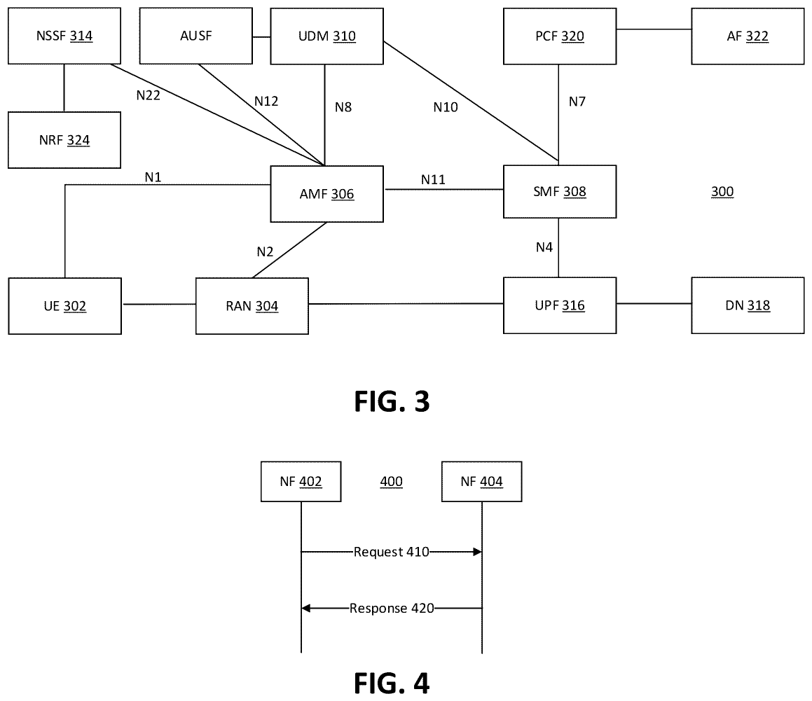

FIG. 3 shows a 5GS architecture 300, according to some arrangements. The 5GS architecture 300 includes various NFs, including a UE 302, a Radio Access Network (RAN) 304 (e.g., a 5G-RAN), and an Access and Mobility Management Function (AMF) 306. An example of the UE 302 includes the UE 104 and 204. The RAN 304 includes for example the BS 102 or 202. As used herein, a “network” may be used to refer to the blocks in FIG. 3 other than the UE 302. As used herein, a “core network” or “CN” may be used to refer to the blocks in FIG. 3 other than the UE 302 and the RAN 304.

The UE 302 and the AMF 306 are connected via the Non-Access-Stratum (NAS) interface N1. The UE 302 and the RAN 304 are connected via a suitable network connection such as the communication link or channel 110 or 250. The AMF 306 includes functionalities such as UE Mobility Management, Reachability Management, Connection Management and Registration Management. The AMF 306 terminates the RAN Control Plane (CP) interface N2 and NAS interface N1, NAS ciphering and integrity protection. The AMF 306 also distributes the Session Management (SM) NAS to the proper Session Management Functions (SMFs) 308 via N11 interface.

During a Registration procedure, the AMF 306 determines Allowed Network Slice Selection Assistance Information (NSSAI), Rejected NSSAI with cause value based on the Requested NSSAI received from the UE 302. The AMF 306 further determines the Registration Area within which the UE 302 can use all Single NSSAI (S-NSSAIs) of the Allowed NSSAI. The AMF 306 sends the Allowed NSSAI, the Rejected NSSAI with cause value and the Registration Area to the UE 302.

The Unified Data Management (UDM) 310 is an NF that manages the subscription profile for the UEs 302. The subscription data is stored in the Unified Data Repository (UDR). The subscription information includes the network slice related subscription data used for Mobility Management and Session Management. The AMF 306 and SMF 308 retrieve the subscription data from the UDM 310.

The Network Slice Selection Function (NSSF) 314 is an NF that supports selecting the set of network slice instances serving the UE 302, determining the Allowed NSSAI and, if needed, the mapping to the Home Public Land Mobile Network (HPLMN) S-NSSAIs, determining the Configured NSSAI and, if needed, the mapping to the HPLMN S-NSSAIs, determining the AMF Set to be used to serve the UE 302, or, based on configuration, a list of candidate AMF(s), possibly by querying the Network Repository Function (NRF) 324. The AMF 306 and the UDM 310 are connected via interface N8. The AMF 306 and the Authentication Server Function (AUSF) 312 are connected via interface N12. The AMF 306 and the NSSF 314 are connected via interface N22.

The SMF 308 is an NF configured for session establishment, modification and release, UE Internet Protocol (IP) address allocation and management, selection and control of User Plane (UP) functions, and so on. The SMF 308 and the UDM 310 are connected via interface N10.

The User Plane Function (UPF) 316 is an NF that serves as an anchor point for intra/inter-Radio Access Technology (RAT) mobility and as the external Protocol Data Unit (PDU) session point of interconnect to Data Network (DN) 318. The UPF 316 also routes and forwards the data packet according to the indication from the SMF 308 and buffers the downlink (DL) data when the UE 302 is in idle mode. The SMF 308 and the UPF 316 are connected via interface N4.

The Policy Control Function (PCF) 320 is an NF supports unified policy framework to govern network behavior. The PCF 320 provides access management policy to AMF 306, or session management policy to SMF 308, or UE policy to the UE 302. The PCF 320 can access the UDR to obtain the subscription information relevant for policy decisions. The PCF 320 and the SMF 308 are connected via interface N7. The PCF 320 is communicably coupled to the Application Function (AF) 322.

Interfaces N7, N8, N12, N10, N11, N12 and N22 are service-based interfaces. Interfaces of N1 and N2 are not service based interface. In current deployment, NG-RANs are always deployed statically. That is, the location of the NG-RAN does not change often. The present arrangements provide service-based interfaces at N1 and N2 to improve flexibility and scalability in dynamical deployment.

FIG. 4 is a diagram illustrating an example communication method 400 between two NFs 402 and 404, according to various arrangements. The method 400 outlines a communication (request-response) protocol between the NF 402 and NF 404. The NF 402 is a CP NF service consumer. The NF 404 is a CP NF service producer. The NF 404 is requested by the NF 402 to provide an NF service. As shown, the NF 403 sends a request 410 to the NF 404 to request the NF service from NF 404. The NF 404 provides a service in the response 420, where the service includes performing an action, providing information, or both. Different NFs can offer different capabilities and different NF services to different consumers. Before NF 402 invokes the services of NF 404, NF 402 can perform a discovery procedure to retrieve the NF instance which provides the expected NF services offered by NF 404.

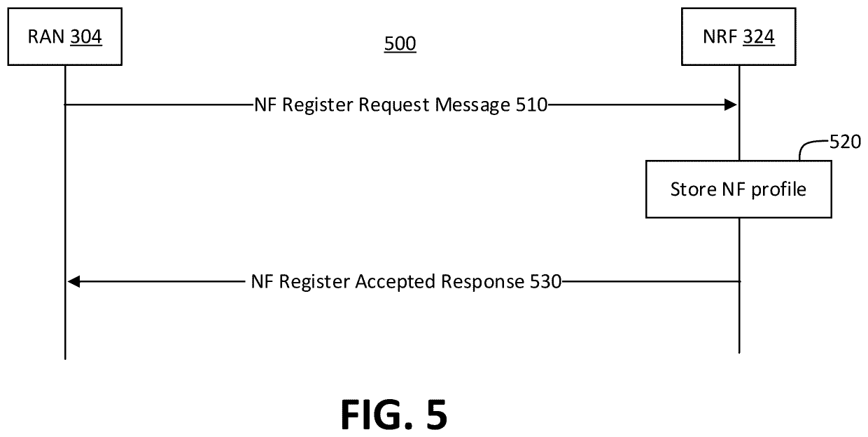

In some examples, the N2 interface between the RAN 304 (e.g., NG-RAN) and the AMF 306 is implemented as a service-based interface. The RAN 304 is considered as a NF that can provide different NF services and can also consume the services of other NFs. Before the NG-RAN services are consumed by other NFs, the NG-RAN services are registered to the NRF 324 with a profile. Other NFs can discover the NG-RAN services via retrieving the NG-RAN profile from the NRF 324. FIG. 5 is an example registration method 500 for registering RAN services (e.g., NG-RAN services), according to various arrangements.

At 510, the RAN 304 (e.g., the NG-RAN, including for example the BS 102 or 202) sends an NF register request message to the NRF 324 to inform the NRF 324 of the NF profile of the RAN 304. The NF register request message can be a Nnrf_NFManagement_NFRegister Request. The NF register request message includes the NF profile. The NF register request message can be sent in response to determining that the NF service consumer of the NF service corresponding to the NF profile becomes operative for the first time.

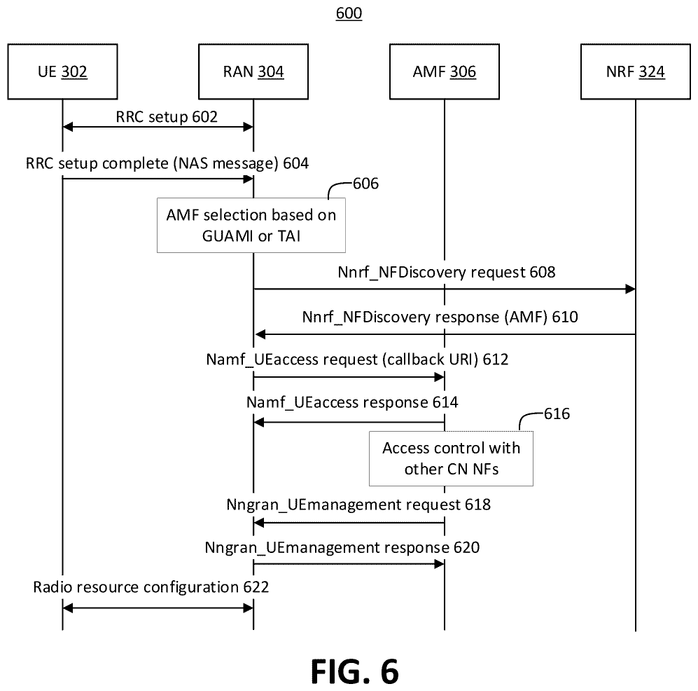

The NF profile of the RAN 304 includes one or more of: at least one Tracking Area Identity (TAI), a RAN identifier (ID) (e.g., a Global NG-RAN ID), a Public Land Mobile Network (PLMN) list, a supported S-NSSAI list, a TAI Network Slice AS Group (NSAG) support list, a supported feature list, a paging Discontinuous Reception (DRX), callback Uniform Resource Identifier (URI), or so on. In some examples, the supported S-NSSAI list can contain pairs of the TAI and supported S-NSSAI in such TAI. The supported feature list can indicate whether the RAN 304 supports more than one feature or not. A callback link (e.g., the callback URI) is used for other NFs which retrieve the profile of the RAN 304 from the NRF 324, to send the notification to the RAN 304. This callback URI can be stored in the profile of the RAN 304 in the NRF 324 or transferred from the RAN 304 to the AMF 306 during the access procedure (e.g., FIG. 6).

In the examples in which the RAN 304 provides two or more services, there may be multiple callback URIs, one for each service provided by the RAN 304. In some arrangements, the callback URI provided in the access procedure (e.g., FIG. 6) is used only for the UE access service operation. Other callback URIs can be retrieved from the NRF 324 by other NFs responsive to such NFs starting to invoke other service operations of the RAN 304. In some arrangements, the RAN 304 provides all callback URIs for different service operations to the AMF 306. The AMF 306 decides the callback URI to be send to other NFs based on the information included in the NAS message.

In the examples in which the RAN 304 provides multiple services, a common callback URI corresponding to two or more services can be allocated. When another NF sends the first notification to RAN 304 with the common callback URI, the RAN 304 can update the callback URI in a subsequent message.

At 520, the NRF 324 stores the NF profile of the RAN 304. The NRF 324 can mark the service consumer of RAN 304 available. At 530, the NRF 324 acknowledges that the registration is accepted via a response, such as an Nnrf_NFManagement_NFRegister response.

FIG. 6 is a diagram illustrating an example method 600 of an access procedure, according to various arrangements. The method 600 is performed for the UE 302 to access the wireless or cellular network via the RAN 304 (e.g., NG-RAN) supporting service based interface N2. When the UE 302 in the idle mode and initiates registration or service request procedure to the network, the communications among the UE 302, the RAN 304, the AMF 306, and the NRF 324 are shown in FIG. 6.

The UE initiates registration or service request to the network, for example, by performing Radio Resource Control (RRC) setup with the RAN 304 (e.g., one or more base stations) at 602. The UE 302 initiate the RRC setup procedure (e.g., by sending an RRC setup request to the RAN 304) before sending a NAS message. Upon the success of RRC setup, the UE 302 includes the NAS message in the RRC setup complete message at 604. The UE 302 can include a Globally Unique AMF Identifier (GUAMI) in RRC setup complete message to ensure the RAN 304 can select a proper AMF (e.g., the AMF 306).

At 606, the RAN 304 selects an AMF based on the GUAMI or TAI. For example, in response to determining that the RAN 304 has no information for the GUAMI provided by the UE 302, the RAN 304 can perform an AMF discovery procedure to the NRF 324 with the TAI in which the UE 302 camps in. The AMF discovery procedure can include 608 and 610. At 608, the RAN 304 sends an NF discovery request to the NRF 324. For example, the RAN 304 invokes Nnrf_NFDiscovery_Request (AMF, GUAMI, or TAI) from an appropriate configured NRF 324 in the same PLMN. The RAN 304 can also provide other parameters such as S-NSSAI or Network Slice Instance (NSI) ID if available, to retrieve a proper AMF (e.g., the AMF 306) from the NRF 324. The NRF 324 authorizes the Nnrf_NFDiscovery_Request. Based on the NF profile of the expected NF/NF service and the type of RAN 304, the NRF 324 determines whether the RAN 304 is allowed to discover AMF 306. For example, the AMF 306 may only be discoverable by the NF in the same network slice identified by the NSI ID. At 610, if discovery is allowed, the NRF 324 determines a set of at least one AMF instance matching the information included in the Nnrf_NFDiscovery_Request and internal policies of the NRF 324. The NRF 324 sends the NF profile of the at least one AMF 306 to the RAN 304 via Nnrf_NFDiscovery_Request Response message.

In response to determining that the RAN 304 has information for the GUAMI provided by the UE 302, the RAN 304 can select the AMF 306 from the stored information based on the GUAMI provided by the UE 302. In such example, 608 and 610 can be omitted.

At 612, the RAN 304 sends an access request such as a Namf_UEaccess_request (N2 parameters, NAS message) to the selected AMF 306. The NAS message is transparent from the UE 302 to the AMF 306. The N2 parameters include at least one of: the Selected PLMN ID, TAI, Cell ID, Establishment Cause, and the callback URI. The callback URI is used for the AMF 306 to send notification to the RAN 304. The RAN 304 can allocate a UE-RAN ID for the UE 302 and include the same in Namf_UEaccess_request. The AMF 306 stores the RAN ID of the RAN 304 and the UE-RAN ID, if received. The UE-RAN ID can be used for other CN NFs to identify the UE 302 in the RAN 304.

In the RAN service registration procedure described relative to FIG. 5, the callback URI can be stored in the NF profile of the RAN 304 in the NRF 324 or transferred to the AMF 306. In the examples in which the RAN 304 provides two or more services, there may be multiple callback URIs, one for each service provided by the RAN 304. In some arrangements, the callback URI provided by the RAN 304 to AMF 306 at 612 is used only for the UE access service operation (e.g., the method 600). Other callback URIs can be retrieved from the NRF 324 by other NFs responsive to such NFs starting to invoke other service operations of the RAN 304. In some arrangements, the RAN 304 provides all callback URIs for different service operations to the AMF 306 at 612. The AMF 306 can decide the callback URI to be send to other NFs based on the information included in the NAS message. For example, the RAN 304 can provide the callback URIs for other services at 620, for example, upon the success of access control for the UE.

In some arrangements in which the RAN 304 provides multiple services, a common callback URI can be allocated by the RAN 304 corresponding to the multiple services. In response to receiving from another NF the first notification with the common callback URI, the RAN 304 can update the callback URI for the service corresponding to the notification or the other NFs in a subsequent message from the RAN 304 to the another NF.

At 614, the AMF returns a response (e.g., the Namf_UEaccess response) to the RAN 304. At 616, the AMF 306 performs access control for the UE 302. The AMF 306 may communicate with other NFs, e.g. NSSF 314, UDM 310, Network Slice-Specific Authentication and Authorization Function (NSSAAF), and so on for access control.

At 618, in response to determining that the UE is allowed to access the network, the AMF 306 sends a Nngran_UEmanagement request (UE context, NAS message) to the RAN 304. The UE context can include the allowed NSSAI, Quality of Service (QOS) profile, security context, or so on. The NAS message is transfer to the UE 302 transparently. The RAN 304. returns a Nngran_UEmanagement response to the AMF 306 at 620. At 622, the RAN 304 allocates radio resource for the UE 302 and transfer the NAS message to the UE 302.

When the UE 302 is in the connected mode, the UE 302 may initiate an NAS procedure. Considering the integrity protection, all NAS messages are transferred to the AMF 306. The AMF 306 decides which service of other CN NFs to be invoked. As the N2 interface is changed to a service-based interface and the RAN 304 is enhanced to a NF providing at least one services, other CN NF can communicate with the RAN 304 directly (e.g., not via the AMF 306). The PDU session establishment, modification, and deactivation procedures are example communications that can be performed directly between the other CN NF and the RAN 304.

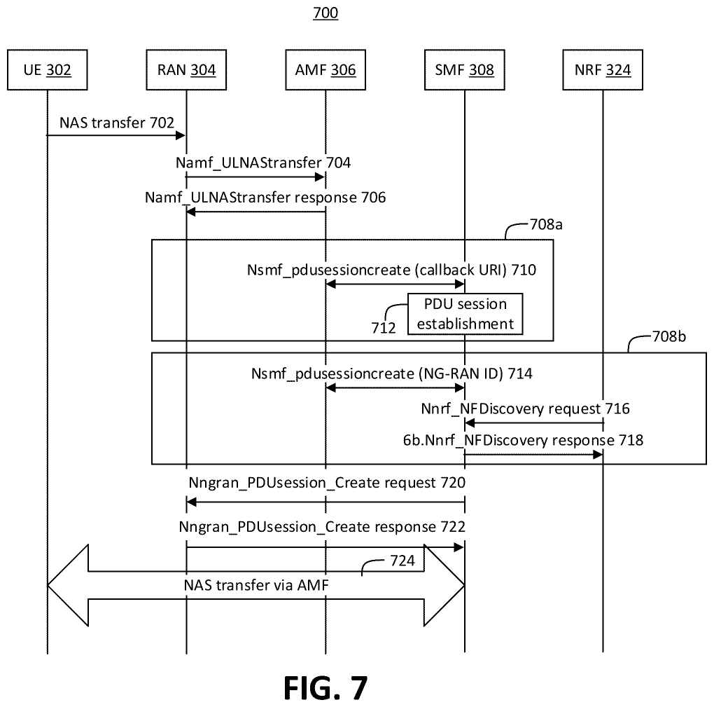

FIG. 7 is a diagram illustrating an example method 700 of a PDU session establishment procedure, according to various arrangements. The method 700 is performed for the UE 302 to establish a PDU session when the UE is in the connected mode (established using the method 600), the communications among the UE 302, the RAN 304, the AMF 306, the SMF 308, and the NRF 324 are shown in FIG. 7.

At 702, the UE 302 initiates the PDU session establishment procedure and sends an NAS transfer message (e.g., an UL NAS transfer message) to the RAN 304. The NAS transfer message includes a PDU Session ID, a request type, a UE requested Data Network Name (DNN), an N1 Session Management (SM) container (PDU Session Establishment Request), and so on. At 704, the RAN 304 sends a Namf_ULNAStransfer message to the AMF 306, and the AMF 306 sends a Namf_ULNAStransfer response to the RAN 304 at 706. At 704 and 706, the RAN 304 invokes the Namf_ULNAStransfer to transfer the NAS message to the AMF 306 transparently.

Callback URI transfer can be performed using 708a or 708b. 708a can be used in the examples in which the RAN 304 has provided the callback URI to the AMF 306 during the access procedure 600. At 710, AMF 306 sends to the SMF 308 a PDU session creation request (e.g., the Nsmf_PDUSession_CreateSMContext Request or Nsmf_pdusessioncreate request) that includes the callback URI of the RAN 304. At 712, the SMF 308 establishes the PDU session, the callback URI corresponds to the PDU session. In response to determining that the RAN 304 has provided two or more callback URIs for the services of RAN 304 to the AMF 306 in the method 600, the AMF 306 can select one of the two or more callback URIs for PDU service. For example, the RAN 304 can indicate a first callback URI for handling PDU session and a second callback URI for handling policy. The AMF 306 can determine that the first callback URI is used in the method 700 based on the information of the NAS message that indicates PDU session.

708b can be used in the examples in which the RAN 304 has provided the callback URI to the NRF 324 and stored in NF profile of the RAN 304 in the NRF 324 (e.g., as described in FIG. 5). At 714, the AMF 306 sends to the SMF 308 a PDU session creation request (e.g., the Nsmf_PDUSession_CreateSMContext Request or Nsmf_pdusessioncreate request) that includes the ID of the RAN 304 (e.g., the NG-RAN ID) to the SMF 308. The SMF 308 uses the ID of the RAN 304 to retrieve the NF profile of the RAN 304 stored in the NRF 324 that is associated with the ID of the RAN 304. For example, at 716, the SMF 308 sends a discovery request (e.g., the Nnrf_NFDiscovery request) to the NRF 324, the discovery request includes the ID of the RAN 304. The NRF 324 looks up the ID of the RAN 304 and sends a response (e.g., Nnrf_NFDiscovery response) at 718, the response includes the callback URI. The SMF 308 establishes the PDU session, the callback URI corresponds to the PDU session.

In the example in which RAN 304 has provided two or more callback URIs for each service of RAN 304 to the NRF as described in FIG. 5, the SMF 308 selects a proper callback URI for PDU session handling. For example, the RAN 304 can indicate a first callback URI for PDU session handling and a second callback URI for policy handling. Then SMF 308 selects the first callback URI to send message.

In 708a and 708b, in the examples in which the AMF 306 receives the UE-RAN ID as described in FIG. 6, the AMF 306 includes the UE-RAN ID it in the PDU session creation request (e.g., the Nsmf_PDUSession_CreateSMContext Request or Nsmf_pdusessioncreate request) to the SMF 308.

At 720, upon completion of the resource reservation in CN (e.g., by the UPF 316), the SMF 308 sends a PDU session create request (e.g., the Nngran_PDUsession_Create request) to the RAN 304. The PDU session create request includes the CN tunnel info, one or multiple QoS profiles and the corresponding QOS Flow IDs (QFIs), PDU session ID, and associated S-NSSAI, User Plane Security Enforcement information, and so on. Upon the request, the RAN 304 reserves the radio resource for the PDU session of the UE 302. At 722, the RAN 304 sends a PDU session create response (e.g., the Nngran_PDUsession_Create response) to the SMF 308.

In the examples in which the UE-RAN ID is received in the Nsmf_PDUSession_CreateSMContext Request, the SMF 308 includes the UE-RAN ID in the Nngran_PDUsession_Create request. This is the UE-RAN ID used for the RAN 304 to determine the UE 302 for which the PDU session is established. In the examples in which the callback URI is allocated per UE, and UE-RAN ID is not allocated, the SMF 308 can use the callback URI to indicate the UE 302 for which the PDU session is established. In the examples in which the callback URI is not allocated per UE, the RAN 304 allocates an UE-RAN ID.

At 724, the UE 302 and the SMF 308 performs NAS transfer via the AMF 306. For example, the SMF 308 sends Namf_Communication_NIN2MessageTransfer message to the AMF 306 to transfer the N1 PDU session establishment accept message to the UE 302. This message does not include any N2 information.

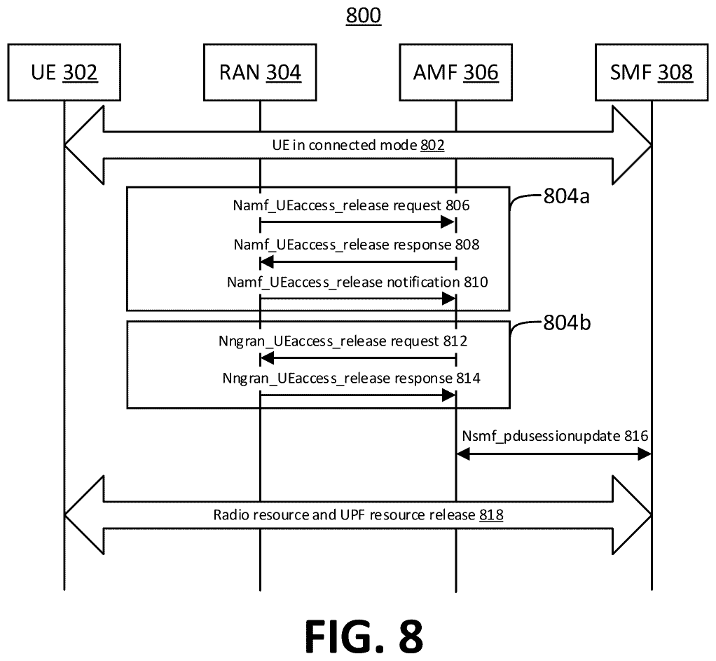

When the UE 302 enters the idle mode, the callback URI can be released. FIG. 8 is a diagram illustrating an example method 800 for releasing the callback URI, according to various arrangements. The method 800 by the UE 302, the RAN 304, the AMF 306, and the SMF 308.

At 802, the UE 302 is in the connected mode. The UE 302 has established one or more PDU sessions according to the method 700. The release procedure in the method 800 can be triggered by the RAN 304 (e.g., NG-RAN) or the AMF 306. The release of the callback URI can be performed via 804a or 804b.

In 804a, the release of the callback URI is triggered by the RAN 304. At 806, the RAN 304 sends a UE access release request (e.g., the Namf_UEaccess_release request) to the AMF 306. The UE access release request can include the UE-RAN ID, cause, and the list of at least one PDU Session ID. The cause indicates the reason for the release, e.g., Access Network (AN) Link Failure, Operations and Maintenance (O&M) intervention, unspecified failure, or so on. The List of PDU Session ID(s) indicates the PDU Sessions served by the RAN 304 (e.g., (R)AN) of the UE 302. At 808, the AMF 808 returns a UE access release response (e.g., the Namf_UEaccess_release response) to the RAN 304. After the radio resource is released, the RAN 304 confirms the UE access release by sending a UE access release notification (e.g., Namf_UEaccess_release notification) to the AMF 306 at 810.

In 804b, the release of the callback URI is triggered by the AMF 306. At 812, the AMF 306 sends a UE access release request (e.g., the Nngran_UEaccess_release request) to the RAN 304. At 814, the RAN 304 returns a UE access release response (e.g., the Nngran_UEaccess_release response) which includes the cause and the list of at least one PDU session ID. The cause indicates the reason for the release (e.g., AN Link Failure, O&M intervention, unspecified failure, etc.). The List of at least one PDU Session ID indicates the PDU Sessions served by the RAN 304 (e.g., (R)AN) of the UE 302.

For each of the at least one PDU session indicated in the list of at least one PDU session ID at 806 or 814, the AMF 306 sends a PDU session update request (e.g., the Nsmf_PDUSession_UpdateSMContext request or Nsmf_pdusessionupdate) that includes the at least one PDU session ID, PDU session deactivation, cause, operation type, and so on, at 816. The cause is the same cause specified in 806 or 814. The UE-RAN ID (e.g., an ID identifying the UE 302) can be included in the PDU session update request message, in the examples in which the UE-RAN ID is included in 806 or 814. The SMF 308 removes the callback URI of NG-RAN service(s) related with the UE 302. The SMF 308 can identify the UE 302 by the UE-RAN ID or Subscriber Permanent Identifier (SUPI)/Subscription Concealed Identifier (SUCI) received from the AMF 306. The SMF 308 can remove the UE-RAN ID if available. The SMF 308 initiates PDU session release to the UPF 316 to release the N3 resource at 818.

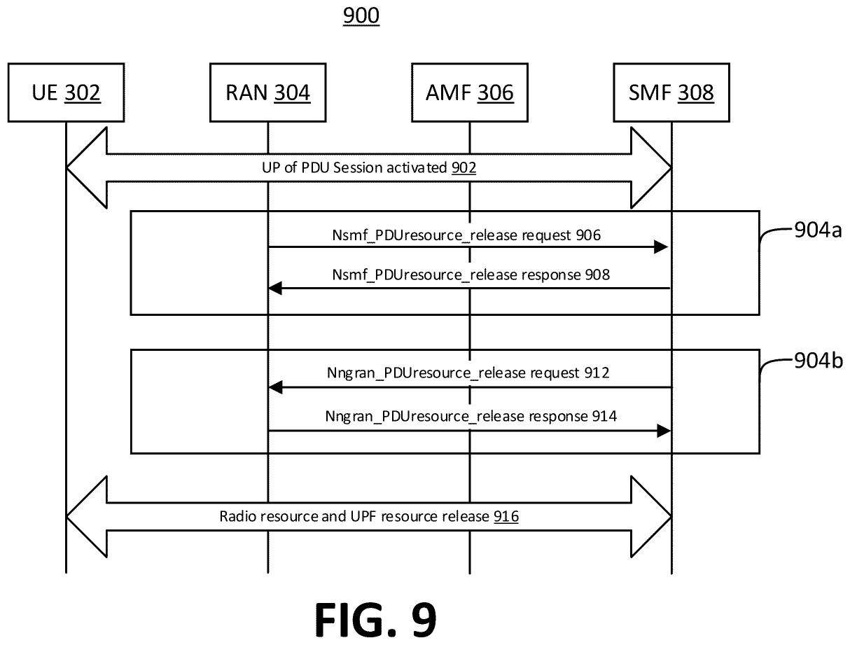

For 804, 816 may be is optional. The UP connection of the PDU session may be deactivated via 904a in FIG. 9 (e.g., the RAN 304 informs the SMF 308 directly) rather than directly via the AMF 306 at 816.

The RAN 304 or the SMF 308 can deactivate UP connection (e.g., data radio bearer and N3 tunnel) for an established PDU session of the UE 302 in Connection Management (CM)-CONNECTED state as described in FIG. 9. FIG. 9 is a diagram illustrating an example method 900 for deactivating an UP connection, according to various arrangements.

At 902, the UP of PDU session is activated. The UE 302 is in the connected mode. The UE 302 has established one or more PDU sessions. At least one of these PDU sessions has the UP connection. The RAN 304 (e.g., 904a) or the SMF 308 (e.g., 904b) can determine to deactivate the UP connection.

In 904a, the UP connection deactivation procedure is triggered by the RAN 304. For example, at 906, the RAN 304 initiates UP connection deactivation e.g., due to limited resource, inactivity by sending to the SMF 308 a PDU resource release request (e.g., the Nsmf_PDUresource_release request) including the UE-RAN ID, PDU session ID, and cause. The cause indicates the reason for the release, e.g., AN link failure, O&M intervention, unspecified failure, etc. The UE-RAN ID and PDU session ID indicate that UP connection of the PDU session is to be deactivated. The SMF 308 can also determine the associated PDU session of the UE 302 based on the binding association exchanged for example as described in FIG. 7. In the example in which a binding association is per UE per PDU session between the RAN 304 and the SMF 308, the binding association can be included instead of UE-RAN ID and PDU session ID. At 908, the SMF 308 sends a PDU resource release response (e.g., the Nsmf_PDUresource_release response) to the RAN 304.

In 904b, the UP connection deactivation procedure is triggered by the SMF 308. At 308, the SMF 308 determines to deactivate the UP connection of the PDU session, e.g., in response to the UPF 316 detecting that the PDU session has no data transfer for an inactivity period, or in response to determining that the UE 302 has moved out of the service area of the RAN 304. The SMF 308 at 912 sends a PDU resource release request (e.g., Nngran_PDUresource_release request) that includes UE-RAN ID, PDU session ID, cause) to the RAN 304. The cause indicates the reason for the release. The UE-RAN ID and PDU session IID indicate that UP connection of the PDU session is to be deactivated. The RAN 304 can also determine the associated PDU session of the UE 302 based on the binding association exchanged as described in FIG. 7. In the example in which a binding association is per UE per PDU session between the RAN 304 and the SMF 308, the binding association can be included instead of UE-RAN ID and PDU session ID. At 914, the RAN 304 sends a PDU resource release response (e.g., the Nngran_PDUresource_release response) to the RAN SMF 308.

The SMF 308 removes the callback URI of NG-RAN service(s) related with the UE 302. The SMF 308 can identify the UE 302 by the UE-RAN ID or SUPI/SUCI received from the AMF 306. The SMF 308 can remove the UE-RAN ID if available. The SMF 308 initiates PDU session release to the UPF 316 to release the N3 resource at 916.

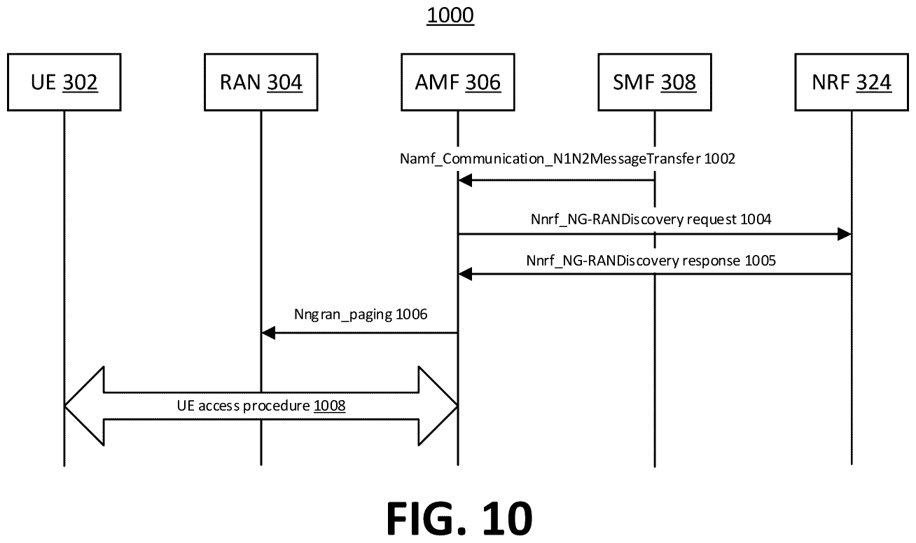

In some arrangements, when the UE 302 is in the idle mode, and there is pending data or SM signaling in the network, the SMF 308 can notify the AMF 306 to trigger a paging procedure described with respect to FIG. 10. FIG. 10 is a diagram illustrating an example method 1000 for a paging procedure, according to various arrangements.

When a UPF 316 receives downlink data for a PDU session and there is no AN tunnel information stored in the UPF 316 for the PDU Session, the UPF 316 can notify the SMF 308 or forward the downlink data to the SMF 308. When the SMF 308 invokes a service of the RAN 304 or receives the downlink data or notification of the buffering downlink data, the SMF 308 checks whether there is a binding information or callback URI of the RAN 304. If there is no binding information or callback URI, the SMF 308 sends to the AMF 306 a message transfer request (e.g., the Namf_Communication_NIN2MessageTransfer) including the SUPI and PDU Session ID, at 1002. The PDU session ID indicates the PDU session to which the signaling or data is related.

The AMF 306 can perform the NG-RAN discovery procedure with the NRF 324 using the TAIs which are included in the registration area, in the examples in which there is no NG-RAN information for the TAI. For example, the AMF 306 can send a RAN discovery request (e.g., the Nnrf_NG-RANDiscovery request) at 1004. The NRF 324 can provide the NF profile of the RAN 304, including the callback URI corresponding to paging to the AMF 306, in the Ran discovery response (e.g., the Nnrf_NG-RANDiscovery response) at 1005. The AMF 306 can invoke the discovery procedure for each TAI included in the registration area. In the examples in which the AMF 306 has retrieved the NG-RAN based on the same TAI, the AMF 306 may not retrieve the NG-RAN for each UE.

At 1006, the AMF 306 sends a paging trigger (e.g., Nngran_paging) including the Global Unique Temporary Identifier (GUTI) to the RAN 304 to trigger the paging procedure. In the example in which the AMF 306 retrieves two or more RANs 304 at 1004, the AMF 306 can send the page for each of the two or more Nngran_paging to these RANs 304. Upon receiving the page, the UE 302 initiates a service request procedure described in FIG. 6. The UE 302 can perform the UE access procedure at 1008.

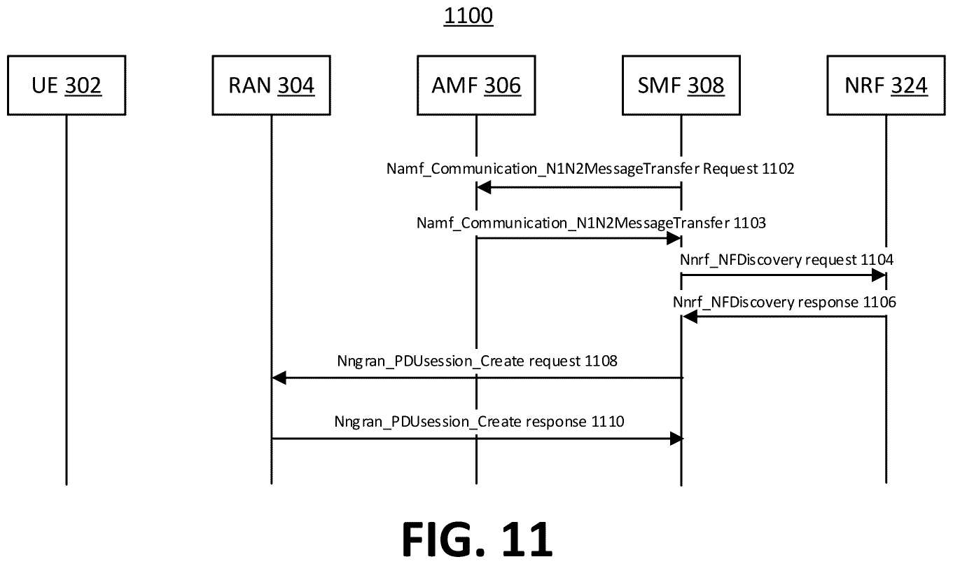

When the UE 302 is in connected mode and there is pending data or SM signaling in the network, the SMF 308 can interact with the AMF 306 to retrieve the information (e.g., the callback URI) of the RAN 304, for example, as shown in FIG. 11. FIG. 11 is an example method 1100 for a notification procedure, according to some arrangements.

When a UPF 316 receives downlink data for a PDU session and there is no AN tunnel information stored in the UPF 316 for the PDU Session, the UPF 316 can notify the SMF 308 or forward the downlink data to the SMF 308. When the SMF 308 invokes a service of the RAN 304 or receives the downlink data or notification of the buffering downlink data, the SMF 308 checks whether there is a binding information or callback URI of the RAN 304. If there is no binding information or callback URI, the SMF 308 sends to the AMF 306 a message transfer request (e.g., the Namf_Communication_NIN2MessageTransfer) including the SUPI and PDU Session ID, at 1102. The PDU session ID indicates the PDU session to which the signaling or data is related.

Given that the UE 302 is in the connected mode, the AMF 306 can provide the information of the RAN 304 (e.g., NG-RAN information) to the SMF 308. Based on the different options of callback URI transfer, two options can be implemented.

In some examples in which the RAN 304 has provided the callback URI during the access procedure as defined in FIG. 6, the AMF 306 returns the message transfer response (e.g., the Namf_Communication_NIN2MessageTransfer response) including the callback URI and the UE-RAN ID at 1103. In response to determining that the RAN 304 has provided two or more callback URIs for the services of RAN 304 to the AMF 306 in the method 600, the AMF 306 can select one of the two or more callback URIs for PDU service. For example, the RAN 304 can indicate a first callback URI for handling PDU session and a second callback URI for handling policy. The AMF 306 can determine that the first callback URI is used in the method 1100 based on the information of the NAS message that indicates PDU session. In such examples, blocks 1104 and 1106 can be omitted.

In some examples in which the RAN 304 provides callback URI to the NRF 324 and stored in NF profile of the RAN 304 in the NRF 324, the AMF 306 returns the Namf_Communication_NIN2MessageTransfer response including the ID of the RAN 304 (e.g., NG-RAN ID) and UE-RAN ID at 1103. The SMF 308 uses the ID of the RAN 304 to retrieve the NF profile of the RAN 304 (e.g., NG-RAN profile) stored in the NRF 324. For example, at 1104, the SMF 308 sends an NF discovery request (e.g., the Nnrf_NFDiscovery request) to the NRF 324, the NF discovery request comprises an ID of the RAN 304. The NRF 324 determines, using the ID of the RAN 304, the corresponding NF profile of the RAN 304 and provides the same to the SMF 308 in the NF discovery response (e.g., the Nnrf_NFDiscovery response) at 1106.

In response to determining that the RAN 304 has provided two or more callback URIs for the services of RAN 304 to the NRF 324 in the method 500, the SMF 308 can select one of the two or more callback URIs for PDU service. For example, the RAN 304 can indicate a first callback URI for handling PDU session and a second callback URI for handling policy. The SMF 308 can determine that the first callback URI is used in the method 1100.

At 1108, upon completion of the resource reservation in CN (e.g., UPF 316), the SMF 308 sends a PDU session create request (e.g., the Nngran_PDUsession_Create request) to the RAN 304. The PDU session create request includes the CN tunnel info, one or multiple QoS profiles and the corresponding QFIs, PDU session ID, and associated S-NSSAI, UP Security Enforcement information, and so on. In the examples in which the UE-RAN ID is received in the Nsmf_PDUSession_CreateSMContext Request, the SMF 308 includes the UE-RAN ID in the Nngran_PDUsession_Create request. The UE-RAN ID is used for the RAN 304 to determine the UE 302 for which the PDU session is established. In the examples in which the callback URI is allocated per UE, and UE-RAN ID is not allocated, the SMF 308 can use the callback URI to indicate the UE 302 for which the PDU session is established. In the examples in which the callback URI is not allocated per UE, the RAN 304 allocates an UE-RAN ID.

In the example in which the AMF 306 or NRF 324 has returned a common callback URI, the RAN 304 can update the callback URI for the service corresponding to request from the SMF 308.

Upon the request, the RAN 304 reserves the radio resource for the PDU session of the UE 302. At 1110, the RAN 304 sends a PDU session create response (e.g., the Nngran_PDUsession_Create response) to the SMF 308.

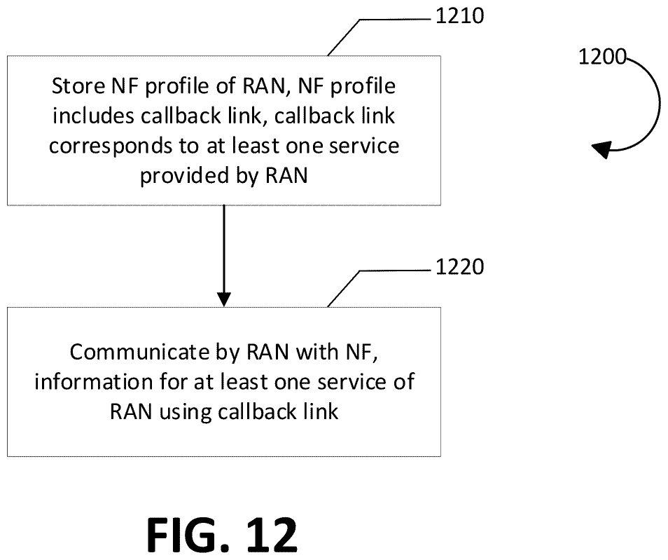

FIG. 12 is a flowchart diagram illustrating an example method 1200 for using an NF profile of a RAN, according to various arrangements. At 1210, the NF profile of the RAN is stored. The NF profile includes a callback link (e.g., a callback URI). The callback link corresponds to at least one service provided by the RAN. In some examples, an NF such as the AMF or the NRF stores the NF profile of the RAN that includes the callback link.

At 1220, the RAN can communicate with an NF information (e.g., notification) for the at least one service of the RAN using the callback link. For example, the NF (e.g., AMF, NRF, or so on) storing the NF profile, including the callback link, can send the callback URI to another NF that wants to communicate with the RAN.

In some examples, storing the NF profile of the RAN includes sending, by the RAN to NRF, an NF register request message including the NF profile of the RAN, the NF profile includes the callback link, and storing, by the NRF, the NF profile of the RAN.

In some examples, the NF profile includes one or more of: at least one TAI, a RAN ID (e.g., Global NG-RAN ID), a PLMN list; a supported S-NSSAI list, a TAI NSAG support list, a supported feature list, or a paging DRX, one or more callback links, wherein the callback link includes a callback URI.

With regard to UE Registration, the at least one service includes a plurality of services. In some examples, the callback link includes a plurality of callback links, each of the plurality of callback links corresponds to a respective one of the plurality of services. A first callback link of the plurality of callback links corresponds to an access service operation of the plurality of services in which a UE attempts to access a network via the RAN. A second callback link of the plurality of callback links corresponds to another service of the plurality of services. In some examples, the callback link includes a common callback link corresponding to the plurality of services, the common callback link corresponds to the access service operation and the another service. In some examples, the method 1200 includes sending, by the RAN to an AMF, only the first callback link during the access service operation. In some examples, the method 1200 includes sending, by the RAN to an AMF, the plurality of callback links during the access service operation, the AMF determining to send and sends the second callback link to an NF other than the RAN or the NRF in response to determining that the access service operation for the wireless communication device is successful.

In some examples, the method 1200 includes the at least one service includes a plurality of services. In some examples, the callback link includes a common callback link corresponding to the plurality of services, and in response to receiving from the NF a request including the common callback link in connection with one of the plurality of services, the RAN sends to the NF, an updated callback link corresponding to the one of the plurality of services, the updated callback link being different from the common callback link. In some examples, the callback link includes a plurality of callback links, each of the plurality of callback links corresponds to a respective one of the plurality of services.

In some examples, the method 1200 includes performing, by the RAN with a UE, an RRC setup procedure. In response to completing the RRC setup procedure, the RAN selects an AMF based on an identifier (GUAMI) provided by the UE. In response to determining that the RAN has information on the identifier, the AMF is selected. In response to determining that the RAN lacks the information on the identifier, an NF profile of the AMF is obtained from the NRF.

With regard to PDU session establishment, in a PDU session establishment procedure, an AMF sends to an SMF a PDU session creation request (e.g., Nsmf_PDUSession_CreateSMContext Request or Nsmf_pdusessioncreate request), where the PDU session creation request including the callback link. The SMF establishes a PDU session corresponding to the callback link. The AMF selects the callback link from the plurality of callback links that correspond to the PDU session establishment procedure.

In some examples, in a PDU session establishment procedure, an AMF sends to a SMF a PDU session creation request (e.g., Nsmf_PDUSession_CreateSMContext Request or Nsmf_pdusessioncreate request). The PDU session creation request includes an ID of the RAN. The SMF retrieves from the NRF the callback link of the RAN from the NRF based on the ID of the RAN. The SMF establishes a PDU session corresponding to the callback link. In some examples, retrieving the callback link includes retrieving a plurality of callback links corresponding to the ID of the RAN. The SMF selects the callback link from the plurality of callback links that correspond to the PDU session establishment procedure.

In some examples, in a PDU session establishment procedure, the SMF sends to the RAN, a PDU session create request. The PDU session create request includes a UE-RAN ID identifying a UE for which a PDU session is established or the PDU session identifying the RAN for which the PDU session is established.

In some examples, the callback link is not allocated for each UE, the UE-RAN ID is allocated. In some examples, the callback link is allocated for each UE, the UE-RAN ID is not allocated, and the callback link is used to identify the RAN for which the PDU session.

In some arrangements relative to the release callback URI, the RAN sends to an AMF a UE access release request (e . . . g, Namf_UEaccess_release request) including at least one PDU session ID for a UE. The AMF sends to a SMF PDU session update request including an ID of the UE (e.g., UE-RAN ID, SUPI, SUCI) and the at least one PDU session ID. The SMF removes the callback link of the service related to the ID of the UE. The SMF releases resources for the at least one PDU session ID.

In some examples, the method 1200 includes receiving, by the RAN from an AMF, a UE access release request (e.g., Nngran_UEaccess_release request), sending, by the RAN to the AMF, a UE access release response (e.g., Nngran_UEaccess_release response) including at least one PDU session ID for the UE, sending by the AMF to a SMF PDU session update request including an ID of the UE (e.g., UE-RAN ID, SUPI, SUCI) and the at least one PDU session ID, removing, by the SMF, the callback link of the service related to the ID of the UE, and releasing, by the SMF, resources for the at least one PDU session ID.

In some arrangements relative to deactivation of UP connection, the method 1200 includes sending, by the RAN to a SMF, a PDU resource release request (e.g., Nsmf_PDUresource_release request) including an ID of the UE and a PDU session ID for the UE, removing, by the SMF, the callback link of the service related to the ID of the UE, and releasing, by the SMF, resources for the PDU session ID.

In some examples, the method 1200 includes receiving, by the RAN from a SMF, a PDU resource release request (e.g., Nsmf_PDUresource_release request) including an ID of the UE and a PDU session ID for the UE, removing, by the SMF, the callback link of the service related to the ID of the UE, and releasing, by the SMF, resources for the PDU session ID.

In some arrangements relative to paging, the method 1200 includes receiving, by an AMF from a SMF, an notification indicating that there is pending data or signaling to the NG-RAN. The notification includes an ID (e.g., SUPI) of a UE and a PDU session ID for the UE. The AMF sends to the RAN a paging message.

In some arrangements relative to notification, the method 1200 includes sending, by a SMF to an AMF, a message transfer request including an ID of a UE (e.g., SUPI) and a PDU session ID, receiving, by the SMF from the AMF, the callback link corresponding to the PDU session ID and the ID of the UE, and send, by the SMF to the RAN, a PDU session create request identifying a UE using UE-RAN ID or callback URI.

In some examples, the method 1200 includes sending, by a SMF to a NRF, an NF discovery request including an ID of the RAN (e.g., SUPI, RAN ID, or so on), receiving, by the SMF from the NRF, the callback link; and sending, by the SMF to the RAN, a PDU session create request identifying a UE.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
storing a Network Function (NF) profile of a Radio Access Network (RAN), wherein the NF profile comprises a callback link, wherein the callback link corresponds to at least one service provided by the RAN; and
communicating, by the RAN with an NF, information for the at least one service of the RAN using the callback link.

2. The wireless communication method of claim 1, wherein storing the NF profile of the RAN comprises:
sending, by the RAN to Network Repository Function (NRF), an NF register request message comprising the NF profile of the RAN, wherein the NF profile comprises the callback link; and
storing, by the NRF, the NF profile of the RAN.

3. The wireless communication method of claim 1, wherein the NF profile comprises at least one of:
at least one Tracking Area Identity (TAI);
a RAN identifier (ID);
a Public Land Mobile Network (PLMN) list;
a supported Single Allowed Network Slice Selection Assistance Information (S-NSSAI) list;
a TAI Network Slice AS Group (NSAG) support list;
a supported feature list; or
a paging Discontinuous Reception (DRX),
the callback link comprises one or more callback links, wherein each of the one or more callback links comprises a callback Uniform Resource Identifier (URI).

4. The wireless communication method of claim 1, wherein
the at least one service comprises a plurality of services; and
one of:
the callback link comprises a plurality of callback links, each of the plurality of callback links corresponds to a respective one of the plurality of services, a first callback link of the plurality of callback links corresponds to an access service operation of the plurality of services in which a wireless communication device attempts to access a network via the RAN, and a second callback link of the plurality of callback links corresponds to another service of the plurality of services; or
the callback link comprises a common callback link corresponding to the plurality of services, the common callback link corresponds to the access service operation and the another service.

5. The wireless communication method of claim 4, comprising sending, by the RAN to a Mobility Management Function (AMF), the first callback link during the access service operation.

6. The wireless communication method of claim 4, comprising sending, by the RAN to a Mobility Management Function (AMF), the plurality of callback links during the access service operation, wherein the AMF determines to send and sends the second callback link to an NF other than the RAN or the NRF in response to determining that the access service operation for the wireless communication device is successful.

7. The wireless communication method of claim 1, wherein
the at least one service comprises a plurality of services; and
one of:
the callback link comprises a common callback link corresponding to the plurality of services, and in response to receiving from the NF a request comprising the common callback link in connection with one of the plurality of services, sending, by the RAN to the NF, an updated callback link corresponding to the one of the plurality of services, the updated callback link being different from the common callback link; or
the callback link comprises a plurality of callback links, each of the plurality of callback links corresponds to a respective one of the plurality of services.

8. The wireless communication method of claim 1, further comprising:
performing, by the RAN with a wireless communication device, a Radio Resource Control (RRC) setup procedure;
in response to completing the RRC setup procedure, selecting, by the RAN, a Mobility Management Function (AMF) based on an identifier provided by a wireless communication device;
in response to determining that the RAN has information on the identifier, selecting the AMF; and
in response to determining that the RAN lacks the information on the identifier, obtaining an NF profile of the AMF from the NRF.

9. The wireless communication method of claim 1, comprising:
in a Protocol Data Unit (PDU) session establishment procedure, sending, by a Mobility Management Function (AMF) to a Session Management Function (SMF) a PDU session creation request, the PDU session creation request comprising the callback link; and
establishing, by the SMF, a PDU session corresponding to the callback link.

10. The wireless communication method of claim 9, comprising selecting, by the AMF, the callback link from the plurality of callback links that correspond to the PDU session establishment procedure.

11. The wireless communication method of claim 1, comprising:
in a Protocol Data Unit (PDU) session establishment procedure, sending, by a Mobility Management Function (AMF) to a Session Management Function (SMF), a PDU session creation request, the PDU session creation request comprising an identifier (ID) of the RAN;
retrieving, by the SMF from the NRF, the callback link of the RAN from the NRF based on the ID of the RAN; and
establishing, by the SMF, a PDU session corresponding to the callback link.

12. The wireless communication method of claim 11, wherein retrieving the callback link comprises retrieving a plurality of callback links corresponding to the ID of the RAN, the wireless communication method comprising selecting, by the SMF, the callback link from the plurality of callback links that correspond to the PDU session establishment procedure.

13. The wireless communication method of claim 1, comprising, in a Protocol Data Unit (PDU) session establishment procedure, sending, by the Session Management Function (SMF) to the RAN, a PDU session create request, wherein the PDU session create request comprises:
a User Equipment (UE)-RAN identifier (ID) identifying a wireless communication device for which a PDU session is established; or
the PDU session identifying the RAN for which the PDU session is established.

14. The wireless communication method of claim 1, wherein:
the callback link is not allocated for each wireless communication device, and the UE-RAN ID is allocated; or
the callback link is allocated for each wireless communication device, the UE-RAN ID is not allocated, and the callback link is used to identify the RAN for which the PDU session.

15. The wireless communication method of claim 1, comprising:
sending, by the RAN to a Mobility Management Function (AMF), a User Equipment (UE) access release request comprising at least one Protocol Data Unit (PDU) session Identifier (ID) for a wireless communication device;
sending, by the AMF to a Session Management Function (SMF) PDU session update request comprising an ID of the wireless communication device and the at least one PDU session ID;
removing, by the SMF, the callback link of the service related to the ID of the wireless communication device; and
releasing, by the SMF, resources for the at least one PDU session ID.

16. The wireless communication method of claim 1, comprising:
receiving, by the RAN from a Mobility Management Function (AMF), a User Equipment (UE) access release request;
sending, by the RAN to the AMF, a UE access release response comprising at least one Protocol Data Unit (PDU) session Identifier (ID) for the wireless communication device;
sending, by the AMF to a Session Management Function (SMF) PDU session update request comprising an ID of the wireless communication device and the at least one PDU session ID;
removing, by the SMF, the callback link of the service related to the ID of the wireless communication device; and
releasing, by the SMF, resources for the at least one PDU session ID.

17. The wireless communication method of claim 1, comprising:
sending, by the RAN to a Session Management Function (SMF), a Protocol Data Unit (PDU) resource release request comprising an ID of the wireless communication device and a PDU session Identifier (ID) for the wireless communication device;
removing, by the SMF, the callback link of the service related to the ID of the wireless communication device; and
releasing, by the SMF, resources for the PDU session ID.

18. The wireless communication method of claim 1, comprising:
receiving, by the RAN from a Session Management Function (SMF), a Protocol Data Unit (PDU) resource release request comprising an ID of the wireless communication device and a PDU session Identifier (ID) for the wireless communication device;
removing, by the SMF, the callback link of the service related to the ID of the wireless communication device; and
releasing, by the SMF, resources for the PDU session ID.

19. The wireless communication method of claim 1, comprising:
receiving, by a Mobility Management Function (AMF) from a Session Management Function (SMF), a notification indicating that there is pending data or signaling to the NG-RAN, wherein the notification comprises an identifier (ID) of a wireless communication device and a Protocol Data Unit (PDU) session ID for the wireless communication device; and
sending, by the AMF to the RAN, paging message.

20. A wireless communication apparatus, comprising:
at least one processor configured to:
store a Network Function (NF) profile of Radio Access Network (RAN), wherein the NF profile comprises a callback link, wherein the callback link corresponds to at least one service provided by the RAN; and
communicate, via a transceiver with an NF, information for the at least one service of the RAN using the callback link.
